(19) United States
(12) Patent Application Publication
(10) Pub. No.: US 2008/0093812 A1
(43) Pub. Date: Apr. 24, 2008

(54) Rolling baggage wheels and method for manufacturing the same

(76) Inventors: Ronald Reed, Chandler, AZ (US); Jeff Yearous, Carlsbad, CA (US); David Shaw, Westlake QLD (AU); Ronnie Jim Lu Shaw, Ontario, CA (US); Ahon Shaw, Long Gang Qu (CN); Henry Wu, Long Gang Qu (CN)

Correspondence Address: STEPTOE & JOHNSON LLP, 1330 CONNECTICUT AVENUE, N.W., WASHINGTON, DC, 20036, US

(21) Appl. No.: 11/802,009

(22) Filed: May 18, 2007

Related U.S. Application Data
(60) Provisional application No. 60/802,117, filed on May 22, 2006.

(51) Int. Cl. B62B 1/10; B60B 19/00

(52) U.S. Cl. 280/47.26; 301/86

(57) ABSTRACT

A wheel for rolling bags and associated assembly methods are provided. The wheel includes a non-inflatable outer tire, a plurality of segments positioned inside the tire concentrically about an axis of the tire and supporting an inner surface of the tire, and first and second rims capping first and second openings in the tire, respectively, and supporting the plurality of segments.

This application claims priority to U.S. Patent Application Ser. No. 60/802,117, filed May 22, 2006.

### BACKGROUND OF THE INVENTION

1. Field of the Invention

The present invention relates to wheels for use in rolling baggage. More specifically, the present invention relates to wheels for rolling baggage which travel easily over natural terrain and travel quietly over tiled surfaces.

2. Discussion of Background Information

Wheels for prior art baggage are typically made of solid plastic or rubber. Due to weight and manufacturing expenses, the wheels are often small and thin, on the order of in-line skate wheels. Indeed, in-line skate wheels are often used for rolling bags. Such wheels tend to be noisy when traveling over flat man-made surfaces, particularly over tiled surfaces where each wheel generates a “clack” sound as it hits joints between tiles. When traveling over loose natural terrain such as gravel, grass or soil, the wheels will dig into the terrain. The bottom of the bag comes to rest on the surface, and the user must drag the bag rather than roll it as intended. People are often forced to carry the bag to avoid dragging it and/or getting the bag dirty.

Other available types of wheels are inappropriate for rolling bags. Thicker solid wheels add too much weight. Hollow plastic wheels used in toys will not support the weight of a loaded bag. Inflatable pneumatic wheels of such a size are difficult to repair and/or reinflate.

### SUMMARY

An embodiment of the present invention provides a non-inflatable wide tire for use in a rolling bag that is durable and reacts like an inflated tire that is not actually inflated. Its wider tire travels across natural surfaces such as dirt, gravel, grass, etc. without the wheels sinking down into the surface as in-line skate wheels do. The underside of the bag remains off the ground and will not drag across the natural surface. This creates a longer life cycle for the bag as well as an easier and smoother pull for the user. The materials and construction of the embodiment of the present invention use a soft-sided tire that allows for a smooth pull across man-made surfaces without the noisy “clack” sound that often accompanies bags with in-line skate wheels. The tire will always keep its shape (within weight tolerances) because it is made of solid components as opposed to an inflated tire that could lose its air. However the tire, wheel and axle combination is lighter than solid wheels of similar dimensions.

According to an embodiment of the invention, a wheel, is provided. The wheel includes a non-inflatable outer tire, a plurality of segments positioned inside the tire concentrically about an axis of the tire and supporting an inner surface of the tire, and first and second rims capping first and second openings in the tire, respectively, and supporting the plurality of segments.

The above embodiment may have various preferable optional features. The non-inflatable outer tire can be made of rubber. The plurality of segments and the first and second rims can be made of acrylonitrile butadiene styrene. The wheel preferably can support a maximum weight of about 500 lbs. The plurality of segments can form a contiguous circle. Each of the plurality of segments may have a curved outwardly facing portion, a flat inwardly facing portion, and/or a plurality of hollow chambers. The wheel may have an outer diameter between approximately 30 mm and approximately 215 mm, particularly 108 mm, and an axial thickness of between approximately 25 and 110 mm, particularly approximately 63 mm. The first rim may have a support configured to mate with an inwardly facing portion of each of the plurality of segments. The support may have a hexagon cross section. The first rim can be a male connector and the second rim a female connector, wherein the first rim at least partially inserts into the second rim. The plurality of segments need not be attached to the first and/or second rims. The wheels are preferably incorporated into a rolling bag.

According to another embodiment of the invention, a method of assembling a wheel is provided. The method includes providing a non-inflatable outer tire, inserting a plurality of segments positioned inside the tire concentrically about an axis of the tire, inserting first and second rims capping first and second openings in the tire, respectively, and supporting the plurality of segments, and inserting an axle through the first and second rims.

The above embodiment may have various preferable optional features. The method may include the step of attaching adjacent ones of the plurality of segments to each other. The tire and at least one of the first or second rim may hold the plurality of segments in place without attachment. The method may include providing a bag, and mounting the wheel on the bag.

According to yet another embodiment of the invention, a rolling bag is provided. The bag includes a storage area, a housing, and a wheel in the housing. Each wheel includes a non-inflatable outer tire, a plurality of segments positioned inside the tire concentrically about an axis of the tire and supporting an inner surface of the tire, and first and second rims capping first and second openings in the tire, respectively, and supporting the plurality of segments.

The above embodiment may have various preferable optional features. The housing may overlap a central axis of the wheel on both sides of the wheel. An axle may passing through the central axis of the wheel and adjacent portions of the housing on both sides of the wheel.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIGS. 1(a)-(c) illustrates an assembly process of a wheel according to an embodiment of the invention;

FIGS. 2(a)-(d) show various views of a non-inflatable tire according to an embodiment of the invention;

FIGS. 3(a)-(d) show various views of an individual segment that supports the outer tire according to an embodiment of the invention;

FIGS. 4(a)-(f) show various views of a first rim according to an embodiment of the invention;

FIGS. 5(a)-(f) show views of various possible alternative configurations of the rims according to embodiments of the invention.

FIGS. 6(a)-(d) show various views of a housing recess that holds the wheel according to an embodiment of the invention;

FIG. 7 shows a housing recess and a wheel mounted on a sports bag according to an embodiment of the invention; and

FIGS. 8(a) and 8(b) show alternate configurations of segments that support a tire according to an embodiment of the present invention.

Several of the above drawings identify various possible dimensions of the corresponding embodiment of the invention, with such dimensions in millimeters.

### DETAILED DESCRIPTION OF EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

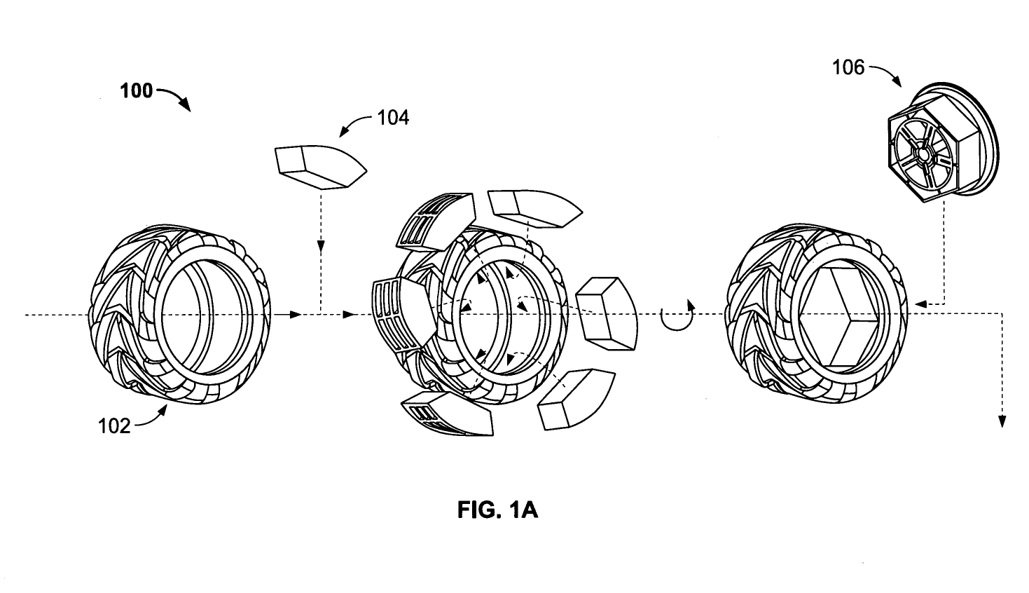

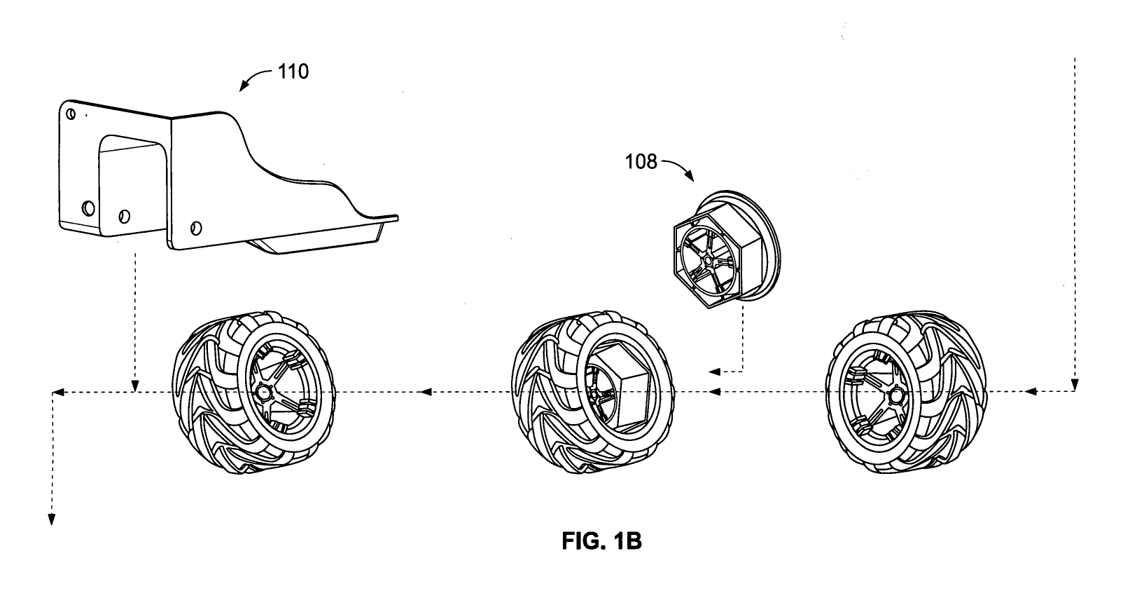

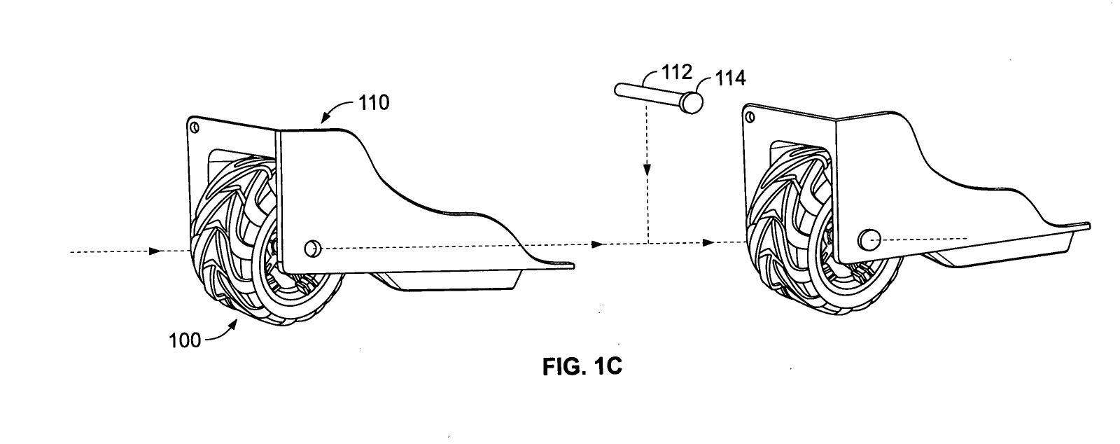

Referring now to FIG. 1, a wheel 100 of the present invention is shown. A non-inflatable hollow tire 102 serves as the outer portion of wheel 100. Six endoskeletal segments 104 are individually inserted into the wheel and held in place by epoxy. A first rim 106 with an internally facing support is inserted into the central hole of tire 102; as discussed below, the outer radial portion of the support is configured to support the inner radial portion of each of the six segments 104. A second rim 108 with an internal support is inserted into the central hole on the opposite side of tire 102 to mate with first rim 106. The two rims support the segments 104, and the segments support the tire 102. Collectively, the entire wheel weighs only a few ounces, but can support upwards of about 500 lbs.

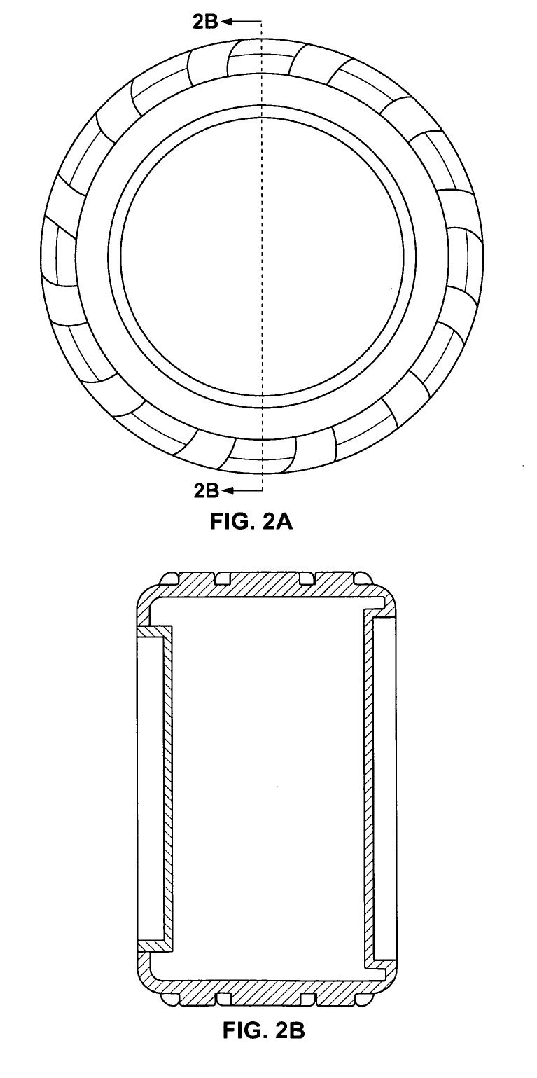

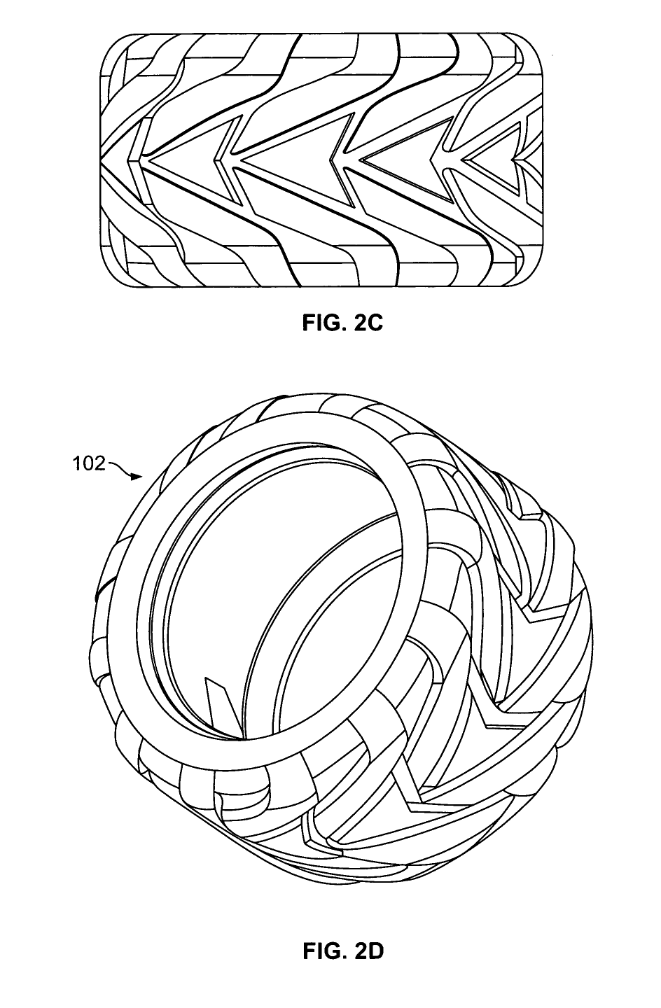

The assembled wheel 100 is inserted into a molded housing recess 110, which may or may not already be attached to a bag (not shown in FIG. 2). Both sides of housing recess 110 have a through hole concentric with a corresponding through hole in first and second rims 106 and 108. An axle 112 is inserted into the through holes and secured with a nut 114. The assembly process repeats for at least one other housing unit 110 to make multiple wheels for a rolling bag.

FIGS. 2(a)-(d) show an example of tire 102. Tire 102 preferably has an outer diameter of approximately 30-215 mm, particularly approximately 108 mm, and a width of approximately 25-110 mm, particularly approximately 63 mm. The outer surface preferably has treads that improve the grip between tire 102 and a natural surface, and a logo (“Fat Boys” in the figures) may be molded onto the side. These dimensions and treads allow the wheel 100 to travel over natural surfaces without sinking, which prior art in-line skate wheel are apt to do. However, the invention is not so limited, as larger and smaller wheels, and/or different (or no) tread designs may be used. Tire 102 is preferably made of rubber, although plastic or other materials may be used. Tire 102 provides a durable surface intended for use against both natural and man-made surfaces.

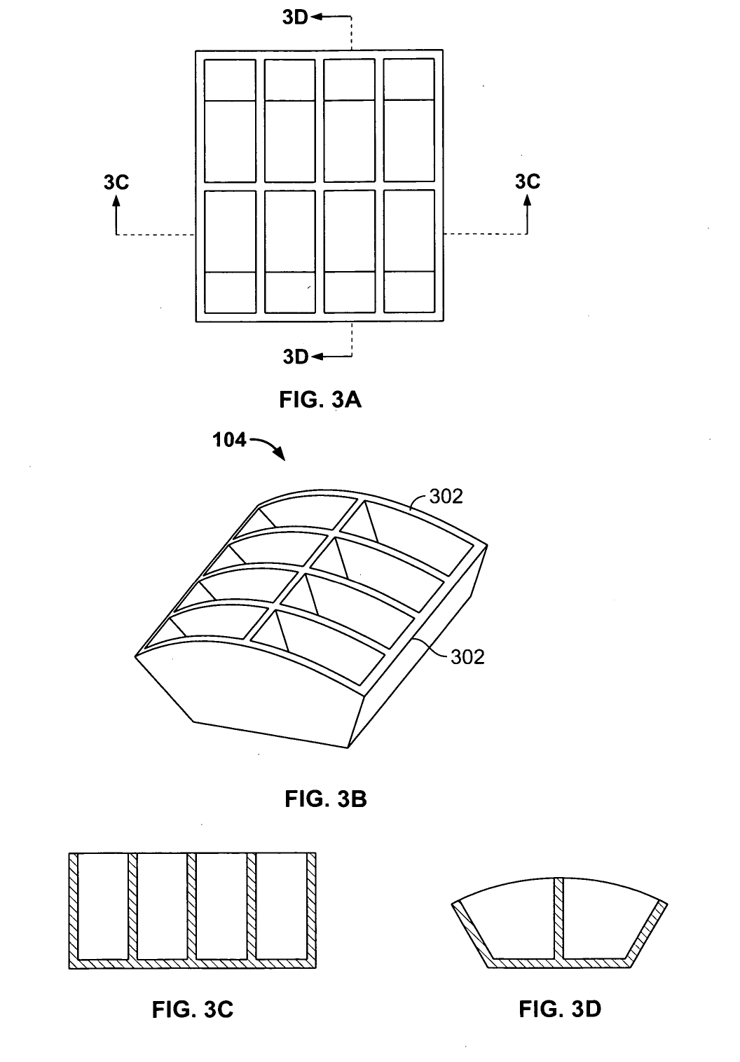

FIGS. 3(a)-(d) show an example of an individual segment 104. The outer portion of each segment 104 is curved to match the radius of curvature of the inner surface of tire 102. Each segment extends over an approximately 60° angle, such that six segments 104 will collectively form a contiguous circle within tire 102. The bottom of each segment 104 is preferably flat to mate with a corresponding flat surface on rims 106 and 108 (discussed below). Several radial and axially extending walls 302 extend from the bottom to the top, defining a plurality of hollow chambers. Eight such chambers are shown in FIGS. 3(a) and 3(b), although any number may be present. Walls 302 will provide support and transfer force from tire 102 to rims 106 and 108, and vice versa. Segments 104 thus take the place of air as a normal inflatable tire would have and prevent tire 102 from collapsing. Because segments 104 are not solid in this embodiment, they provide support with minimal addition of weight.

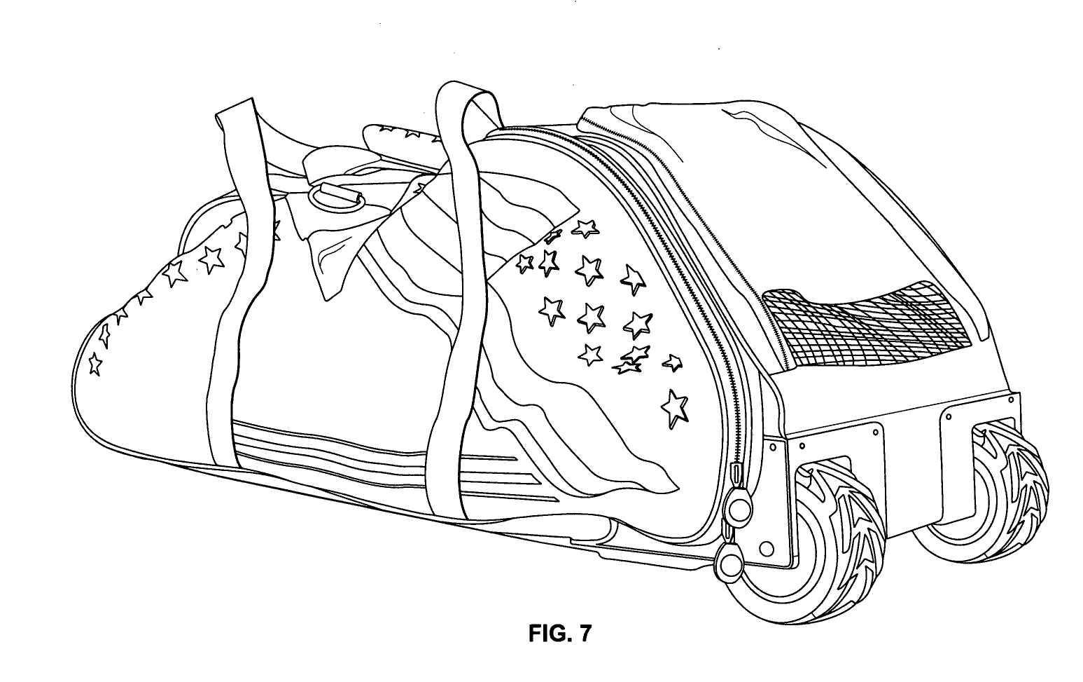

Various modifications could be made to the nature of segments 104 within the skill of the art. Any number of segments could be used, e.g., eight segments of 45° to form an octagon instead of six pieces to form a hexagon. All six pieces need not be used, such that the pieces would not form a contiguous circle. Individual segments could be solid instead of having hollow cavities. The pieces need not be identical. Segments shown individually could be molded or attached together in whole or in part, such as shown in FIGS. 8(a) and 8(b).

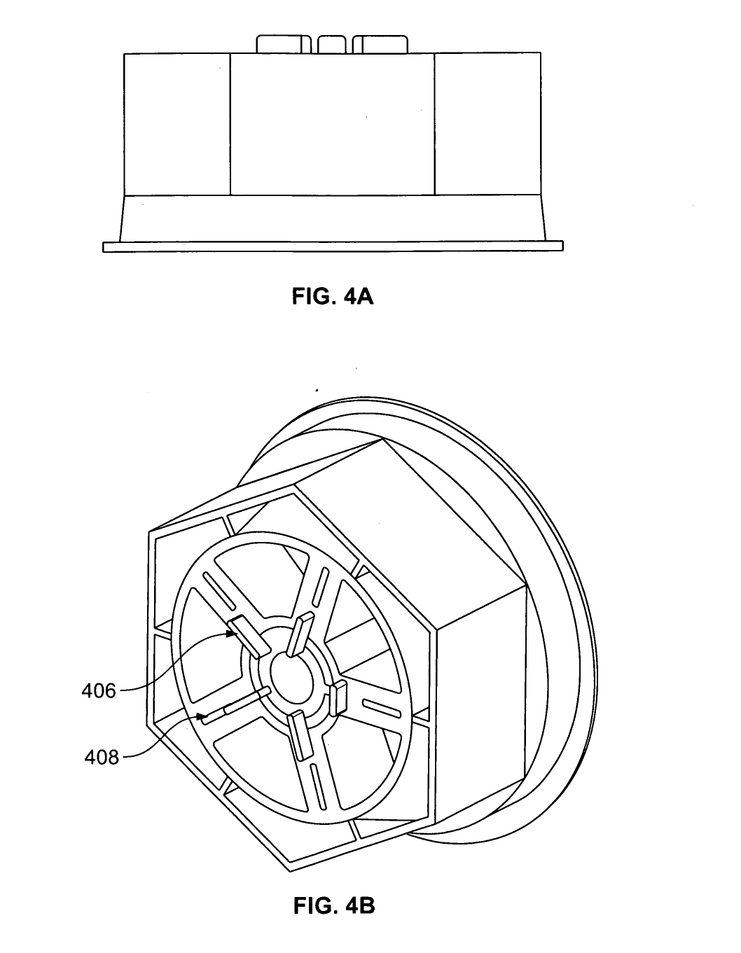

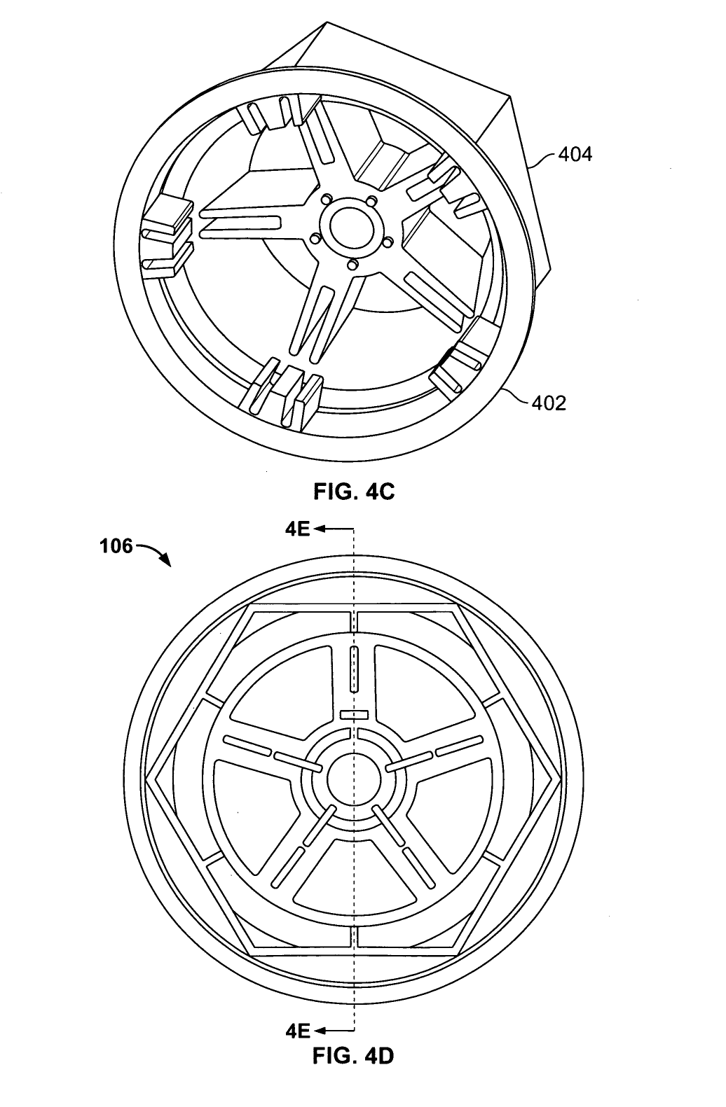

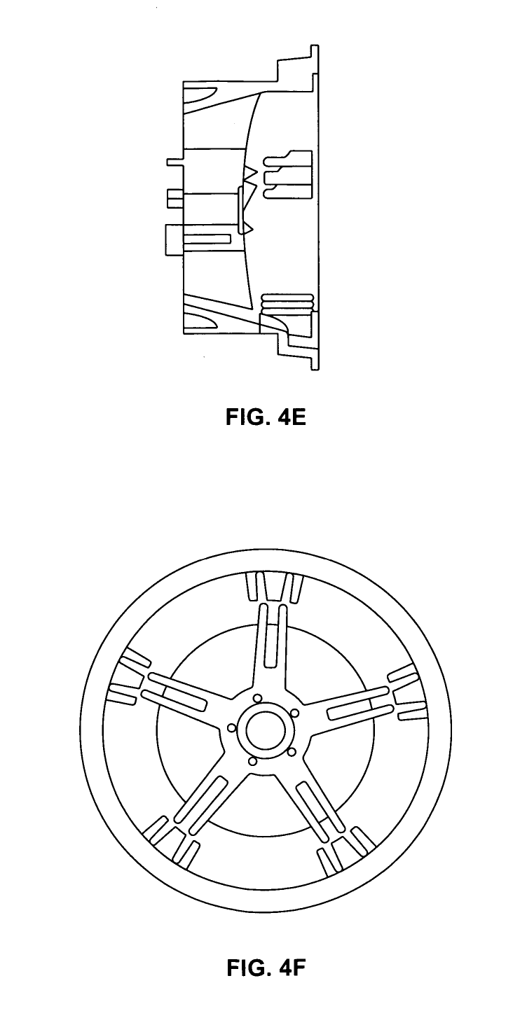

FIGS. 4(a)-(f) show various perspectives and cross sections of first rim 106. As shown, the rim includes an outer circular section 402 and a support section 404 connected by mating structures around the periphery thereof, although an integral unit could also be used. The inwardly facing portion of support section 404 defines a shape that mates with and supports the individual endoskeletal segments 104. Support section 404 is of sufficent length to extend approximately halfway into non-inflatable tire 102. Several protrusions 406 extend inwardly (i.e., into tire 102), and will engage with corresponding recesses in second rim 108. Second rim 108 is preferably identincal to first rim 106, except that the protrusions 406 are replaced with corresponding mating recesses that engge with protrusions 406. The protrusions may be identical and symetrical so to allow for simple engagement. In the alternative, at least one of protrusions 406 may have a different angle, shape or relative from the others to require a specifc orientation of first rim 106 and second rim 108 for assembly purposes.

In this embodiment, first rim 106 may be considered a male connector and second rim 108 a female connector. However, the invention is not so limited. Both rims may have any types or distribution of projections and recesses. Proejctions/ recesses could be omitted altogehter in favor of other known methods of attachment.

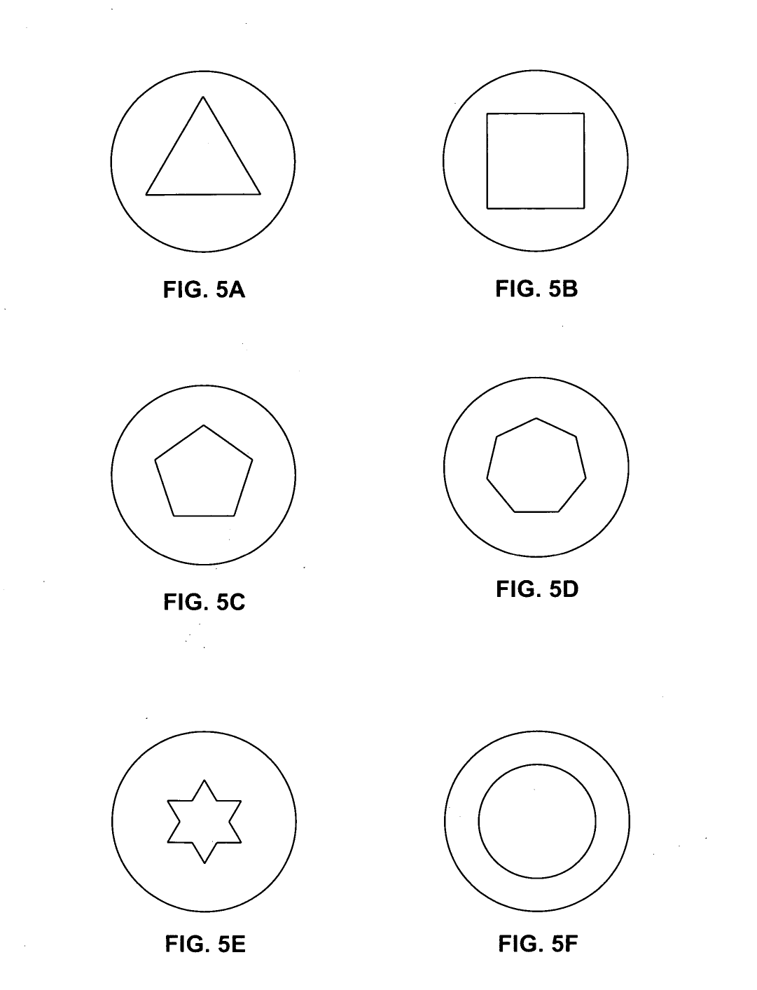

In the preferred emobidment of six segments 104 with flat inward surfaces, support section 404 of first and second rims have a cross section of a hexegon. The invention is not so limited, however, and any appropriate number of sides and shapes may be used based on the number, size and shape of the corresponding segments 104. FIGS. 5(a)-(f) show various non-limiting examples of possible shapes used with rims 106 and 108.

Each segment 104, first rim 106 and second rim 108 are preferably made from molded acrylonitrile butadiene styrene (“ABS”—chemical formula (C₈H₈·C₄H₆·C₃H₃N)ₓ), although other materials could be used. ABS is a common thermoplastic used to make light, rigid, molded products such as protective head gear and toys, including LEGO bricks. It is a copolymer made by polymerizing styrene and acrylonitrile in the presence of polybutadiene. The proportions can vary from 15% to 35% acrylonitrile, 5% to 30% butadiene and 40% to 60% styrene.

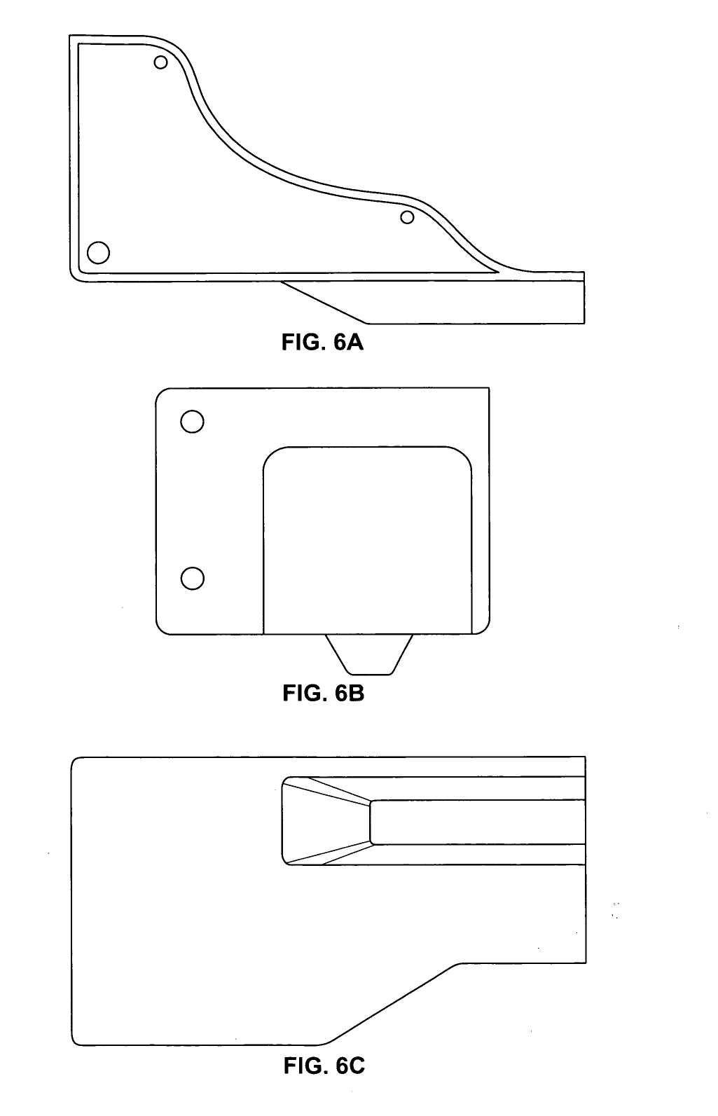

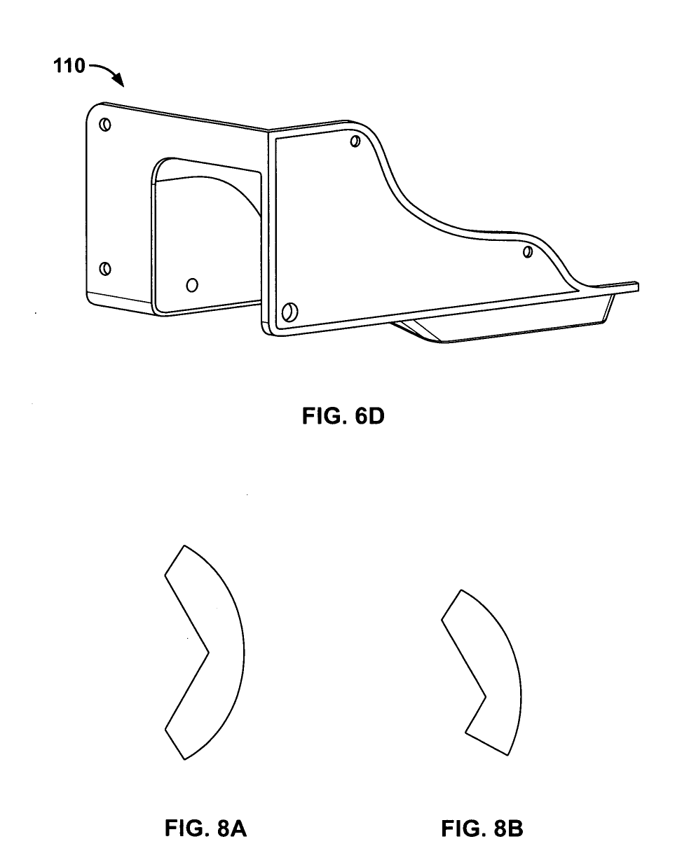

Referring now to FIG. 6(a)-(d), an embodiment of housing recess 110 is shown. Housing recess 110 has an appropriate size and shape to accommodate wheel 100, although considerable latitude is available for artistic modeling. It is preferably made from plastic, but other materials may be used. Housing recess 110 has a through hole on both sides configured concentrically with a corresponding through hole in first and second rims 106 and 108. Axle 112 is inserted into the through holes and secured with nut 114 to rotatably mount wheel 100 to housing recess 110. Axle 112 can be any pin, bolt, screw, rod, etc., that can support the applied weight. A nut 114 is preferred to hold axle 114 in place, but any appropriate securing structure can be used.

FIG. 7 shows the housing recess 110 and wheel 100 mounted on a sports bag. Other types of bags could also be used, such as golf bags, briefcases, luggage etc. Wheels 100 need not be used with a bag at all, but could be incorporated into any similar environments, e.g., carts or toys. Housing recess 110 is preferably made of ABS, although other materials could be used.

In the above embodiment, the radial sides of segments 104 creates a semi-locking environment in which segments 104 can move loosely within tire 102 but do not tend to fall out. The addition of first and second rims 106 and 108 create a tension fit with tire 102 that prevents segments 104 from shifting. Projections 406 in first rim 106 are slightly larger than the corresponding recess in second rim 108, forming a pressure lock engagement that hold the rims together, at least until the assembled wheel 100 is placed in housing 110. The flanking portions of housing 110 that support wheel 110 prevent rims 106 and 108 from separating. The components can thus be assembled without any permanent (e.g. glue) or semi-permanent (e.g, screw) attachment. Of course, the invention is not so limited, and any form of attachment may be additionally and/or alternatively be used.

Preferably each housing 110 includes one wheel 100. However, the invention is not so limited. Each housing 110 may support multiple wheels and/or additional structures.

During testing, the inventors observed that bags with wheels 100 made considerably less noise travelling over man-made surfaces compared with rolling bags that use solid wheels.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims

What is claimed is:

1. A wheel, comprising:
a non-inflatable outer tire;
a plurality of segments positioned inside the tire concentrically about an axis of said tire and supporting an inner surface of said tire; and
first and second rims capping first and second openings in said tire, respectively, and supporting said plurality of segments.

2. The wheel of claim 1, wherein said non-inflatable outer tire is made of rubber.

3. The wheel of claim 1, wherein said plurality of segments are made of acrylonitrile butadiene styrene.

4. The wheel of claim 1, wherein said first and second rims are made of acrylonitrile butadiene styrene.

5. The wheel of claim 1, wherein said wheel can support a maximum weight of about 500 lbs.

6. The wheel of claim 1, wherein said plurality of segments form a contiguous circle.

7. The wheel of claim 1, wherein each of said plurality of segments has a curved outwardly facing portion and a flat inwardly facing portion.

8. The wheel of claim 1, wherein each of said plurality of segments has a plurality of hollow chambers.

9. The wheel of claim 1, wherein said wheel has an outer diameter between approximately 30 mm and approximately 215 mm.

10. The wheel of claim 1, wherein said wheel has an outer diameter of approximately 108 mm.

11. The wheel of claim 11, wherein said wheel has an axial thickness of between approximately 25 and 110 mm.

12. The wheel of claim 1, wherein said wheel has an axial thickness of approximately 63 mm.

13. The wheel of claim 1, wherein said first rim has a support configured to mate with an inwardly facing portion of each of said plurality of segments.

14. The wheel of claim 1, wherein said support has a hexagon cross section.

15. The wheel of claim 1, wherein said first rim is a male connector and said second rim is a female connector, wherein said first rim at least partially inserts into said second rim.

16. A rolling bag configured to be pulled across a surface by an individual, said bag comprising a main storage area and a plurality of wheels as recited in claim 1.

17. The wheel of claim 1, wherein said plurality of segments are not attached to said first and second rims.

18. A method of assembling a wheel, comprising:
providing a non-inflatable outer tire;
inserting a plurality of segments positioned inside the tire concentrically about an axis of said tire;
inserting first and second rims capping first and second openings in said tire, respectively, and supporting said plurality of segments; and
inserting an axle through said first and second rims.

19. The method of claim 18, further comprising attaching adjacent ones of said plurality of segments to each other.

20. The method of claim 19, wherein the tire and at least one of the first or second rim hold the plurality of segments in place without attachment.

21. The method of claim 19, further comprising:
providing a bag; and
mounting the wheel on said bag.

22. A rolling bag, comprising:
a storage area;
a housing;
a wheel in said housing, each said wheel comprising:
a non-inflatable outer tire;
a plurality of segments positioned inside the tire concentrically about an axis of said tire and supporting an inner surface of said tire; and
first and second rims capping first and second openings in said tire, respectively, and supporting said plurality of segments.

23. The rolling bag of claim 22, wherein said housing overlaps a central axis of the wheel on both sides of said wheel.

24. The rolling bag of claim 23, further comprising an axle passing through said central axis of said wheel and adjacent portions of said housing on both sides of said wheel.
